(19) United States
(12) Patent Application Publication
(10) Pub. No.: US 2022/0004821 A1
(43) Pub. Date: Jan. 6, 2022

(54) ADVERSARIAL FACE RECOGNITION

(71) Applicant: PayPal, Inc., San Jose, CA (US)

(72) Inventor: Xiaodong YU, Singapore (SG)

(21) Appl. No.: 16/918,199

(22) Filed: Jul. 1, 2020

(51) Int. Cl. G06K 9/62; G06K 9/00; G06N 3/04

(52) U.S. Cl. CPC G06K 9/6265; G06K 9/00288; G06N 3/04; G06K 9/00268; G06K 9/6215

(57) ABSTRACT

Systems, methods, and computer program products for determining vulnerabilities in a face recognition system (FRS) are provided. An image that includes a face is received at an image synthesizer. The image generates a synthesized image from the image by changing one or more visual attributes of the image. The FRS attempts to authenticate the synthesized image. The synthesizer continues to iteratively change the visual attributes of the image and generate new synthesized images until one of synthesized is authenticated by the FRS.

### TECHNICAL FIELD

The disclosure generally relates to face recognition, and more specifically to identifying vulnerabilities in a face recognition system.

### BACKGROUND

Facial recognition systems are increasingly used in real world applications, such as for authenticating a person's identity. However, while face recognition systems are easy to use, current face recognition systems are not secure. This is because face recognition algorithms use deep learning models which are susceptible to adversarial inputs. The adversarial inputs add imperceptible noise to an image but are imperceptible to a human eye. However, the adversarial inputs may cause a deep learning model in the face recognition system to incorrectly authenticate a user who is not registered or authorized with the face recognition system.

### BRIEF DESCRIPTION OF THE DRAWINGS

FIG. 1 is a computing system where embodiments can be implemented.

FIG. 2 is a diagram of an iterative simulated attack on a face recognition system, according to an embodiment.

FIG. 3 is a diagram of a synthesizer generating a synthesized image, according to an embodiment.

FIG. 4 is a diagram of an image dataset with different orthogonal modes, according to an embodiment.

FIG. 5 is a diagram of synthesized images, according to an embodiment.

FIG. 6 is a diagram of table that illustrates the effect of a change in parameter values on a confidence score, according to an embodiment.

FIG. 7 is a diagram of a successful attack on a face recognition system, according to an embodiment.

FIG. 8 is a flowchart of a method for generating a synthesized image, according to an embodiment.

FIG. 9 is a flowchart of a method for identifying vulnerabilities in a face recognition system, according to an embodiment.

FIG. 10 is a block diagram of a computer system suitable for implementing one or more components or operations in FIGS. 1-9 according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Because face recognition systems are susceptible to adversarial attacks, the embodiments disclose techniques for modeling a simulated attack using synthesized images. The purpose of the simulated attack is to identify vulnerabilities in the face recognition system. An image synthesizer or simply synthesizer may receive an image that includes a face and synthesize images from the image by changing one or more attributes, such as visual attributes associated with the face in the image. In some embodiments, these visual attributes may be independent and non-overlapping attributes, such that the attributes may be modified independently from other attributes. A face recognition system (FRS) may receive a synthesized image and generate a confidence score. The confidence score may indicate whether the synthesized image matches one of the genuine images that are registered with the FRS. If, based on the confidence score, the FRS authenticates the synthesized image, the synthesized image attributes may be examined to determine vulnerability in the FRS. On the other hand, if the FRS does not authenticate the synthesized image, a synthesizer may attempt to further change the attributes of the image until the FRS authenticates the synthesized image. The process may repeat until the FRS either authenticates the synthesized image or determines that synthesized image may not be authenticated.

In some embodiments, an image may be synthesized into a synthesized image using various image synthesis techniques. An example technique may be a multimodal discriminant analysis (NMDA) or generative adversarial network (GAN) synthesis. Both techniques may identify parameters in the image that are associated with the attributes in the image. The image synthesizer may then change the attributes by changing the values of the parameters, and resynthesizing the image using the new parameter values.

In some embodiments, prior to using an image synthesis technique, the image synthesizer may normalize the image. For example, when an image synthesizer receives an image, the image synthesizer may orient the image so that a face in the image has a same or similar orientation as images registered with the FRS. The image synthesizer may also apply one or more masks to the image that cover certain portions of the image. For example, a mask may cover portions of the image that are not a face. In another example, a mask may remove head hair from the face in the image.

Next, the image synthesizer may use a neural network encoder to generate a shape vector that includes image encodings. The encodings may correspond to different attributes in the face in the image. The NMDA may then decompose the shape vector into a parameter vector where one or more parameters in the vector correspond to visual attributes of the face. In some embodiments, the one or more parameters that correspond to a visual attribute do not overlap with other parameters that correspond to other visual attributes. Example attributes may be makeup, beard, and lipstick. In this way, a distinct visual attribute of the face may be modified by modifying the corresponding parameters in the parameter vector. Once the image synthesizer modifies one or more parameters in the parameter vector, the image synthesizer may generate a synthetic image using the modified parameters. For example, the image synthesizer may generate a new shape vector from the modified parameter vector. The synthesizer may then use the neural network decoder to decode the shape vector into a synthesized image.

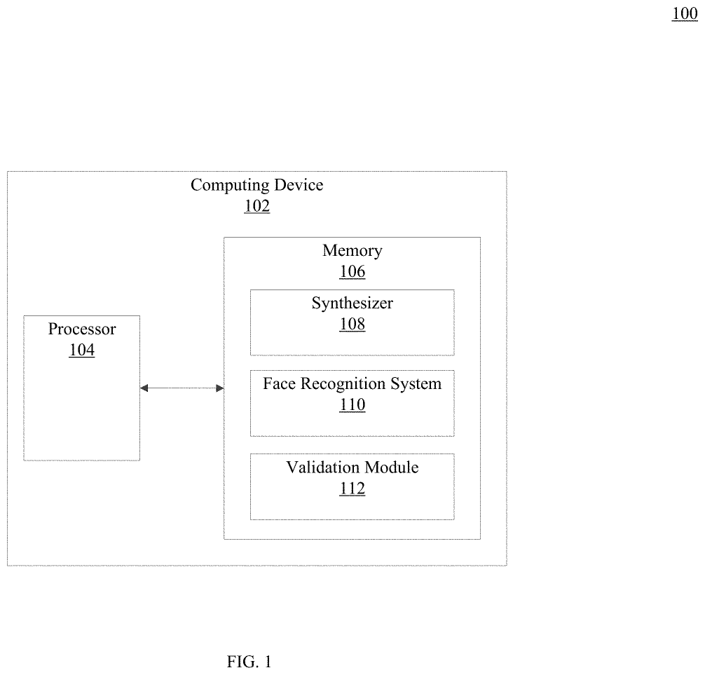

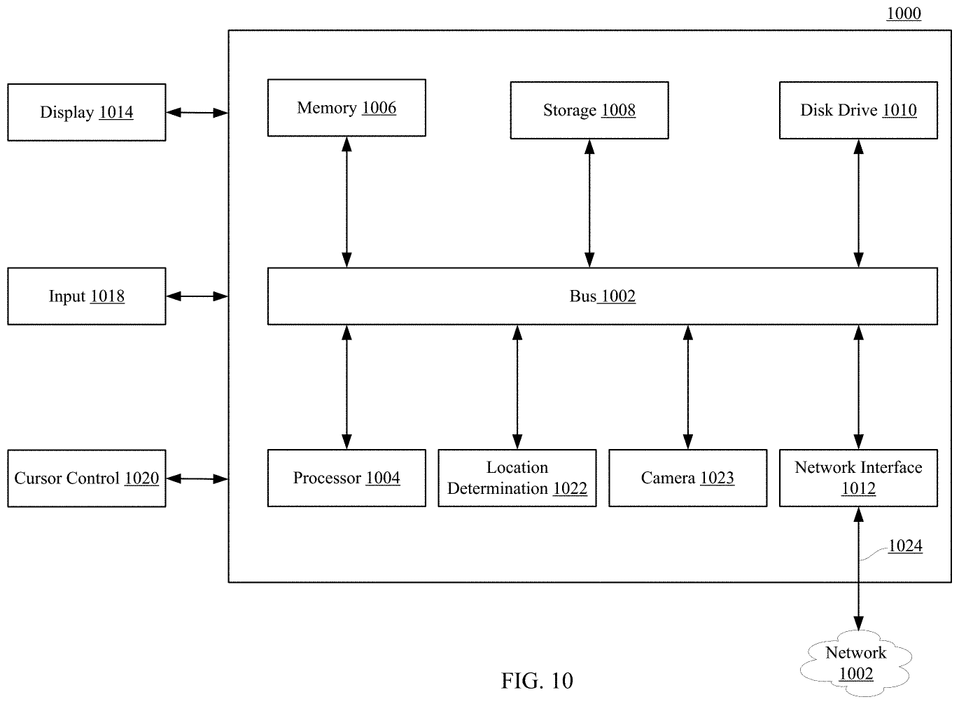

FIG. 1 is a computing system 100 where embodiments can be implemented. System 100 includes a computing device 102 that may be a portable or non-portable electronic device under the control of a user or a server that may act as a back-end for processing data and instructions received from other computing devices. Example computing device 102 is discussed in further detail in FIG. 10.

Computing device 102 includes a processor 104 and a memory 106. Processor 104 and memory 106 are discussed in further detail in FIG. 10. Memory 106 may store an image synthesizer 108 (or simply synthesizer 108), a face recognition system (FRS) 110, and a validation module 112. Although illustrated as being stored in the same memory 106, synthesizer 108, FRS 110, and validation module 112 may be stored in different memories and on different computing devices 102.

FRS 110 may provide authentication functionality to a user requesting access, such as to an application, content, data, a computing device, an account, a website, or a service. To authenticate the user, the user initially registers with FRS 110 by providing one or more images that include a user face and user credentials to FRS 110. FRS 110 may store the images of the registered users in FRS 110 or in a memory or storage coupled to FRS 110. During authentication, FRS 110 receives an image from a user, such as through a user computing device or an image capture device associated with computing device 102, and authenticates the user by comparing the image provided by the user against the registered images. In some embodiments, FRS 110 may include a deep learning model, which is one or more neural networks trained to authenticate images received by FRS 110. For the purposes of the embodiments below, FRS 110 may include any type of a deep learning model and may be considered to be a black box that either authenticates or does not authenticate a received image.

Because FRS 110 includes a deep learning model to authenticate images, FRS 110 may be subject to various adversarial attacks that attempt to cause FRS 110 to authenticate an adversarial image that does not correspond to the registered images. Conventionally, adversarial attacks may add background noise in an image. The background noise may not visually modify the image as discerned by a human eye but may cause FRS 110 to authenticate an adversarial image. To test for such and other vulnerabilities in FRS 110, the embodiments below disclose systems and methods that generate synthesized images by modifying visual attributes of the image and identify the changes that may cause FRS 110 to authenticate the synthesized image.

In some embodiments, synthesizer 108 may test vulnerabilities of FRS 110. To test vulnerabilities, synthesizer 108 may receive an image, which may be an adversarial image and modify the attributes of the image. The attributes may be visible attributes. For example, if an image includes a human face, synthesizer 108 may iteratively modify the attributes of the human face until the modified human face is authenticated by FRS 110. Based on the synthesized image that is authenticated by FRS 110, vulnerabilities in the FRS 110 may be identified. Notably, synthesizer 108 generates a synthesized image by modifying the visible attributes of the image instead of adding background noise which may or may not be visible to the human eye to the image.

In some embodiments, validation module 112 may validate whether FRS 110 authenticates the synthesized image. As output, FRS 110 may generate a confidence score for an image, including a synthesized image. Validation module 112 may validate whether the confidence score is within a range or above a threshold that indicates that FRS 110 has authenticated the synthesized image.

In some embodiments, synthesizer 108 may iteratively re-synthesize synthesized images until FRS 110 authenticates the synthesized image or synthesizer 108 may not generate any more synthesized images from the original adversarial image.

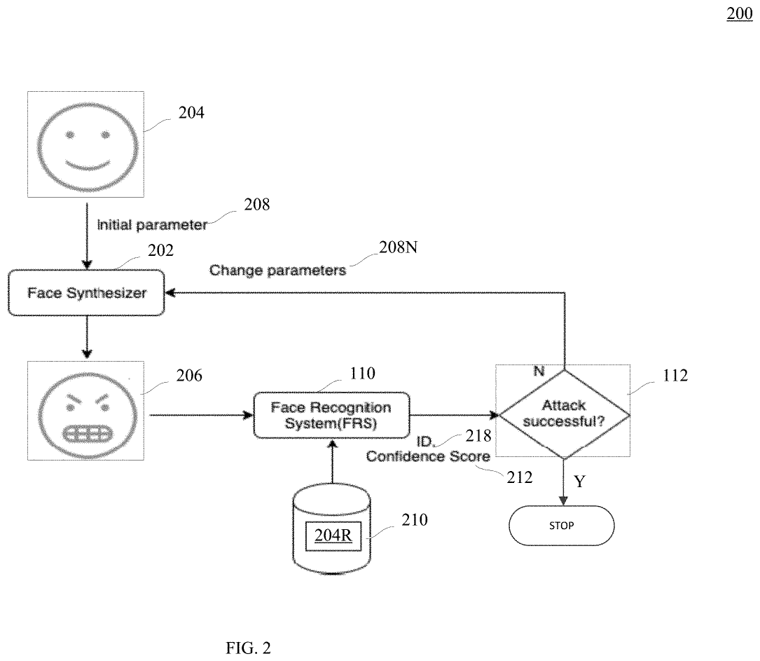

FIG. 2 is a flow diagram 200 that illustrates an iterative simulated attack on a face recognition system, according to an embodiment. As discussed above, the simulation may identify vulnerabilities of FRS 110. FIG. 2 includes FRS 110 and synthesizer 108 shown as a face synthesizer 202, though embodiments may apply to other types of image synthesizers 108. During a first iteration, face synthesizer 202 receives an adversarial image 204. Adversarial image 204 may be an image that includes a human face but that is not registered with FRS 110.

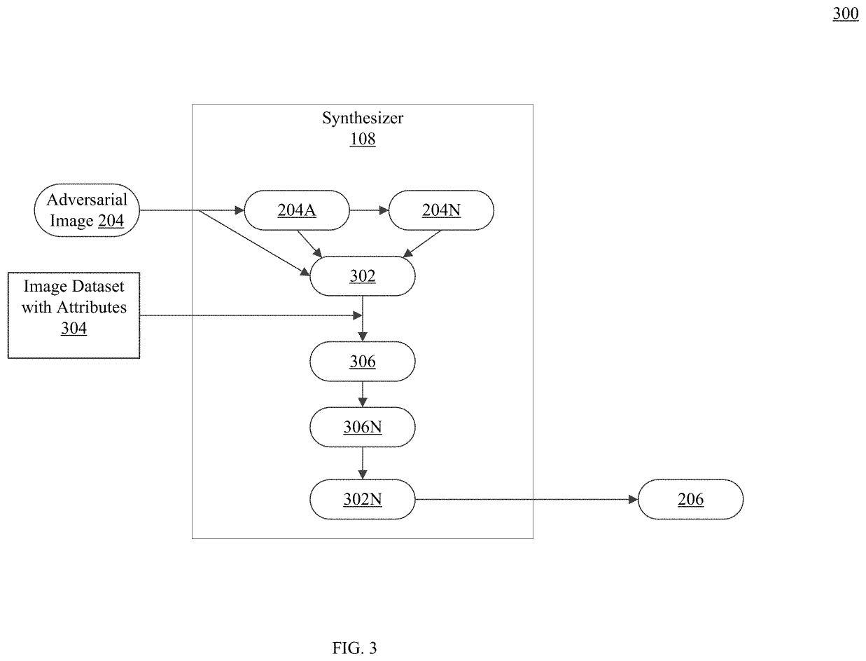

In some embodiments, face synthesizer 202 normalizes a face within adversarial image 204. To normalize the face, face synthesizer 202 may re-orient adversarial image 204 and remove non-face portions of the image, as will be discussed below. Face synthesizer 202 may then synthesize a synthesized image 206 from the face by changing one or more attributes, such as visual attributes of the face. To synthesize synthesized image 206, face synthesizer 202 decomposes the face into one or more parameters, such that the one or more parameters correspond to one or more attributes. In some embodiments, distinct parameters correspond to distinct attributes of the face. Face synthesizer 202 may modify the values of the one or more parameters (as further discussed in detail in FIG. 3) and generate synthesized image 206 using the modified parameters. In some embodiments, during the first iteration, face synthesizer 202 may initialize the parameters with initial parameter values 208.

In some embodiments, to determine vulnerabilities in FRS 110, FRS 110 receives synthesized image 206 generated using face synthesizer 202 and attempts to authenticate synthesized image 206 against registered images 204R. Registered images 204R may be stored in a memory 210 that is included in or coupled to FRS 110. Memory 210 may be one of memories discussed in FIG. 10. Registered images 204R may be images of genuine users that have registered with FRS 110. As FRS 110 may include a deep learning model for authenticating images that FRS 110 receives, FRS 110 may pass synthesized image 206 through the deep learning model which may generate a confidence score 212 for synthesized image 206. FRS 110 may also output an image identifier or ID 218 that corresponds to one of registered image 204R that FRS 110 matches with synthesized image 206.

Validation module 112 may validate confidence score 212. If confidence score 212 is above a configurable threshold as determined by validation module 112, FRS 110 is deemed to authenticate synthesized image 206 as an image that matches one of registered images 204R and the iterative process ends. Notably when validation module 112 determines that FRS 110 authenticates synthesized image 206, the adversarial attack on FRS 110 may be considered to be successful. In this case, synthesized image 206 may be further analyzed to determine vulnerabilities in FRS 110. Also, the deep neural network included in FRS 110 may be trained to identify synthesized image 206 as an adversarial image.

On the other hand, if validation module 112 determines that FRS 110 does not authenticate synthesized image 206 because confidence score 212 is below the configurable threshold, indicating the adversarial attack was not successful, a new iteration of the simulated validation attack occurs. In the next iteration, face synthesizer 202 may modify parameters 208 into new parameters 208N by changing one or more values in parameters 208. Face synthesizer 202 may then generate synthesized image 206 using parameters 208N and FRS 110 may generate confidence score 212 for synthesized image 206. Confidence score 212 may then be validated using validation module 112. The iterative process may continue until FRS 110 authenticates synthesized image 206 or until a condition that may terminate the iterative process is reached. An example condition may occur when face synthesizer 202 may not generate further synthesized images 206 or until a threshold number of iterations is reached.

FIG. 3 is a block diagram 300 of a synthesizer synthesizing an image, according to an embodiment. Synthesizer 108 may be any type of synthesizer that may synthesize image 206 from adversarial image 204. As discussed above, example synthesizers may be an MMDA synthesizer or a GAN synthesizer. In any case, synthesizer 108 may synthesize image 206 by identifying in adversarial image 204, using a neural network, or a combination of neural networks, non-overlapping attributes that correspond to non-overlapping visual attributes in adversarial image, modifying parameters that are associated with the attributes and synthesizing synthesized image 206 using the modified parameters. In some embodiments, the neural network may include an encoder that may identify various parameters in adversarial image 204 and a decoder that may synthesizer synthesized image 206 from the parameters as will be discussed in detail below.

As illustrated in FIG. 3, synthesizer 108 may receive adversarial image 204. In some embodiments, synthesizer 108 may align adversarial image 204, or a face in adversarial image 204 with respect to images 204R. An example alignment may be where a face in adversarial image 204 and faces in images 204R both face in the same direction, e.g. face forward. The aligned adversarial image 204 may be adversarial image 204A.

In some embodiments, synthesizer 108 may normalize adversarial image 204 or 204A by applying one or more masks. A normalized adversarial image 204 or 204A is shown as normalized image 204N. One mask may remove the background from adversarial image 204. Another mask may remove visual attributes that surround or are included in a face in the image. For example, a mask may remove head hair, beard, mustache, eyebrows, etc., from the face in adversarial image 204.

Notably, synthesizer 108 may synthesize adversarial image 204 into synthesized image 206 using adversarial image 204, aligned adversarial image 204A or normalized adversarial image 204N.

In some embodiments, synthesizer 108 may include a neural network or another model that may be used to synthesize adversarial image 204. The neural network may include an encoder that encodes adversarial image 204 into an appearance and shape vector 302 (also referred to as shape vector x below). In some embodiments, the neural network may encode adversarial image 204 that may have been previously normalized using one or more masks. Shape vector 302 may include encodings for different attributes, e.g. visual attributes of adversarial image 204.

As discussed above, in some embodiments, synthesizer 108 may the use a multimodal discriminant analysis (MMDA) to decompose shape vector 302 into parameters that are associated with distinct attributes. For purposes of the MMDA, the attributes may be referred to as modes that have orthogonal subspaces. The orthogonal subspaces identify modes that are independent of each other or which do not exhibit subclass-superclass relationships. In this way, parameters may be associated with a particular attribute, and changing these parameters may change the particular attribute. With respect to image 204 that includes a face, different modes may include different facial attributes, such as an expression attribute, spectacles attribute or makeup attribute.

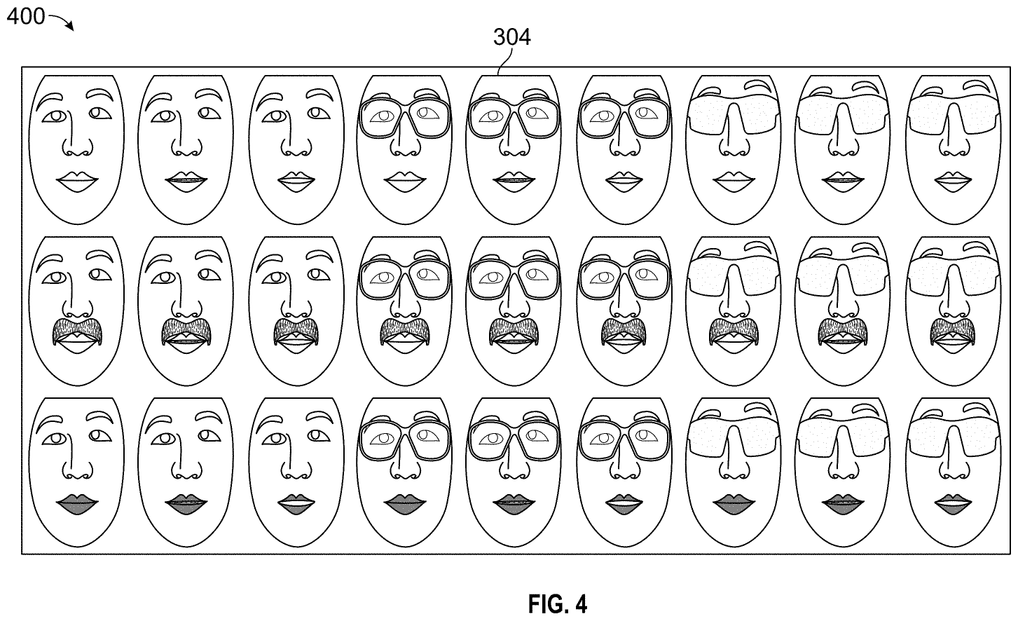

In some embodiments, to perform a MMDA (or another type of synthesis) on adversarial image 204, synthesizer 108 is initially trained to recognize one or more modes. These modes may correspond to one or more attributes. For example, synthesizer 108 may initially be trained on an image dataset with attributes, such as an image dataset 304 with images that include faces that have different attributes. The attributes of the face may include different orthogonal modes with each mode having one or more predefined classes. The orthogonal mode indicates that the attribute that corresponds to one mode is not related or overlaps with another attribute that corresponds to another mode. FIG. 4 is a diagram 400 of an image dataset with different orthogonal modes, according to an embodiment. As illustrated in FIG. 4, image dataset 304 may include faces that have three modes: a makeup mode, a spectacles mode and an expression mode. Notably, the modes in image dataset 304 are exemplary and other modes can also be used. Further, the makeup mode may include different classes, such as no makeup, with beard, and with lipstick. The spectacles mode may include different classes, such as no glasses, with normal glasses, and with sunglasses. The expressions mode may include different classes, such as a normal face, a smile face, and a shock face. In some embodiments, the number of training faces (n) in image dataset 304 may be the number of classes in the makeup mode x the number of types in the spectacles mode X the number of types in the expressions mode. Accordingly, FIG. 4 illustrates images of twenty-seven faces that include faces with different combinations of the three modes (makeup, spectacles, and expressions) and different classes within each mode.

With further reference to FIG. 3, when synthesizer 108 applies a MMDA to image dataset 304, synthesizer 108 generates a matrix V that includes identity spaces for the modes which reveal the class label (identity) of a data point as well as the residual space. Matrix V may be represented as:

V=[V^{m} V^{s} V^{e} V⁰] Equation 1

where V^{m} is an identity space for the makeup mode, V^{s} is an identity space for the spectacles mode, and V^{e} is an identity space for the expressions mode. In some embodiments, V may have dimensions that are (n−1)×(n−1). V⁰ may be the residual space and may contain residual variations that are outside of all identity spaces. In other words, V^{p} (where mode p may be modem, mode s, or mode e) may contain the discriminant information for mode p and not other modes. Such decomposition of modes, allows synthesizer 108 to synthesize faces with different mode classes, and individually vary the attributes associated with the classes.

The embodiments below describe how a MMDA generates V of Equation 1. Suppose matrix X is a training matrix and has dimensions that are D×n. The columns of matrix X are xᵢ where i=1, . . . n with K being a number of different modes. The modes in V above are makeup, spectacles, and expressions, thus K=3. For each mode i there are Cᵢ classes, L₁ⁱ, . . . , L_{C}_{ᵢ}ⁱ (e.g. for the mode makeup there are classes no makeup, with beard, and with lipstick). In some embodiments, image dataset 304 may be matrix X and each training vector xᵢ is multiply labeled with one class label from each mode.

As part of the MMDA, synthesizer 108 computes, for each mode i, a total scatter matrix Sₜⁱ=XX^{T}. Synthesizer 108 may then eigen-decompose matrix Sₜⁱ to generate Sₜⁱ=UDU^{T}, retaining only non-zero eigenvalues in the diagonal matrix D and corresponding eigenvectors in matrix U. Synthesizer 108 may computer matrix P as P=UD^{-1/2}.

To determine Vⁱ, synthesizer 108 may use a Fisher Criterion for each mode i, which is shown below:

J_{F}(Vⁱ)=trace{((Vⁱ)^{T}Š_{w}ⁱ(Vⁱ))⁻¹((Vⁱ)^{T}Š_{b}ⁱ(Vⁱ))} Equation 2

where Vⁱ contains the basis for each subspace, Š_{b}ⁱ contains intra-class scatter matrix, and Š_{w}ⁱ contains the inter-class scatter matrix. Synthesizer 108 may repeat the above process to generate Vⁱ to V^{K}. Synthesizer 108 may compute residual space V⁰ using the Gram-Shmidt algorithm.

Typically, synthesizer 108 may generate matrix V once. Synthesizer 108 may then use matrix V to generate synthesized images 206.

As discussed above, synthesizer 108 generates shape vector x (shape vector 302) from adversarial image 204. Synthesizer 108 may use orthogonal matrix V to decompose the shape vector x into a parameter vector y as shown below:

y=V^{T}P^{T}x Equation 3

Parameter vector y is shown as parameter vector 306 in FIG. 3. Parameter vector y may further be decomposed as follows:

y^{T}=[m s^{T} e^{T} r^{T}] Equation 4

where m, s, and e may include a configurable number of parameters (e.g. two parameters for each mode), and r may include parameters in the residual space. Further, m, s, and e may include values that represent their respective classes. For example, m may be set to values that represent no makeup, with beard and with lipstick; s may be set to values that represent no glasses, with normal glasses and with sunglasses; and e may be set to values that represent a normal face, a smile face, and a shock face. In some embodiments, r may also be set to a configurable number of parameters. Notably, parameters that correspond to different classes, such as m, s, and e, may vary and fewer or more parameters may be used depending on a number of attributes that may be modified when synthesizer 108 generates synthesized image 206 from adversarial image 204.

In some embodiments, to synthesize synthesized image 206, synthesizer 108 may modify the parameters associated with the m, s, and e vectors. Suppose that m, s, and e vectors may be each associated with two parameters. In this case, to synthesize synthesized image 206, synthesizer 108 may modify up to six parameters. Synthesizer 108 may define a parameter vector θ such that θ^{T}=[m₁ m₂ c₁ c₂ e₁ e₂] and includes the six parameters. In this way, parameter vector y may be decomposed as y^{T}=[θ r^{T}].

In some embodiments, once the values in parameter vector θ are modified, the altered parameter vector may be a new parameter vector \tilde{y} (shown as 306N in FIG. 3). Synthesizer 108 may then synthesize a new shape vector \tilde{x}=PᵣV \tilde{y} where Pᵣ is a reversed principle component analysis (PCA) operation of P. The new shape vector \tilde{x} is shown as 302N.

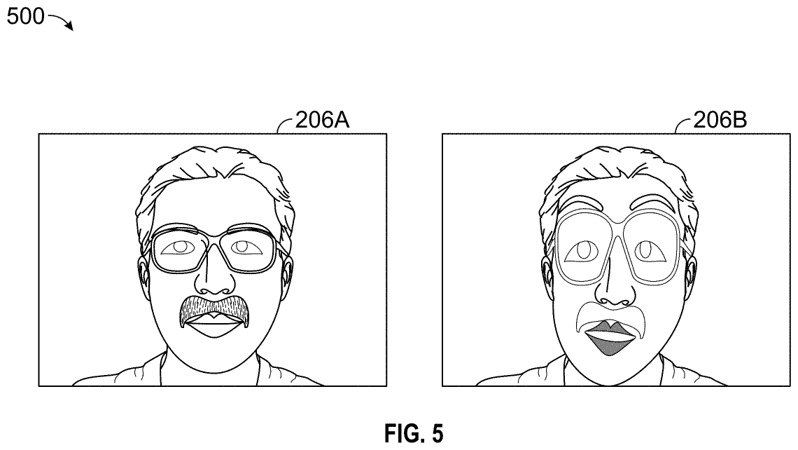

In some embodiments, the neural network in synthesizer 108 may include a decoder. The decoder may decode the new shape vector \tilde{x} into a new face which is synthesized image 206. Synthesizer 108 may also reshape the new face and add attributes such as hair and background using one or more masks. FIG. 5 is a diagram 500 of synthesized images, according to an embodiment. FIG. 5 illustrates two synthesized images 206A and 206B. Synthesized image 206A is a realistic image while synthesized image 206B is an unrealistic image. The difference between the two images are the values of parameters in the parameter vector θ. For example, synthesized image 206A uses parameters θ^{T}=[0.52,0.27, 0.03, 0.20, 0.17, 0.14], whereas synthesized image 206B uses parameters θ^{T}=[−0.37, 0.02, 0.91, 0.71, 0.14, 0.33]. Synthesized images 206A and 206B illustrate that synthesizer 108 may be configured to set constraints for the values of the parameters in order to generate realistic images. The constraints may set the values between two configurable numbers, or above a below a configurable number as discussed below. Notably, the values associated with parameters may vary which results in synthesizer 108 synthesizing more or less realistic images. Further, in some embodiment, the constraints may be set such that the parameters that have values within the constraints generate more realistic image. The values of one or more constraints may be set through experimentation where synthesizer 108 may synthesize synthesized images 206 using different values or combination of values.

With further reference to FIG. 2, once face synthesizer 202 generates synthesized image 206, synthesized image 206 may be used to test vulnerabilities in FRS 110. The test may be modeled as an optimization problem where FRS 110 generates confidence score 212 that indicates a confidence level with which synthesized image 206 matches one of images 204R. Suppose f (0) is confidence score 212 returned by FRS 110 that processed synthesized image 206. Confidence score 212 may be between 0 and 100 in some embodiments, where zero indicates “no confidence” in synthesized image 206 and 100 indicates “high confidence” in synthesized image 206. In some embodiments, confidence score 212 between images of two different persons may be between 20 and 40, whereas confidence score 212 indicating a match between images may be approximately 97.

In some embodiments, validation module 112 may use a distance function to determine whether FRS 110 matches synthesized image 206 with one of images 204R that are registered with FRS 110. An example of distance function may be:

$$d ( f ( θ ) ) = K * {( \frac{f ( θ )}{100} - t )}^{2} \qquad Equation 5$$

where K=1000 and t=0.9. The optimization problem may then be defined as:

$${argmin}_{θ} d ( f ( θ ) ) \qquad Equation 6$$

In some embodiments, validation module 112 may constrain the optimization problem to be as close to a confidence score=90. Because the values of parameters in parameter vector θ change the face in synthesized image 206, face synthesizer 202 may experiment with different parameter values at each iteration to determine whether FRS 110 authenticates synthesized image 206. Additionally, the system in FIG. 2 may assign initial values to the parameters in the parameter vector θ during the first iteration and constrain the values of one or more parameters within a predefined range.

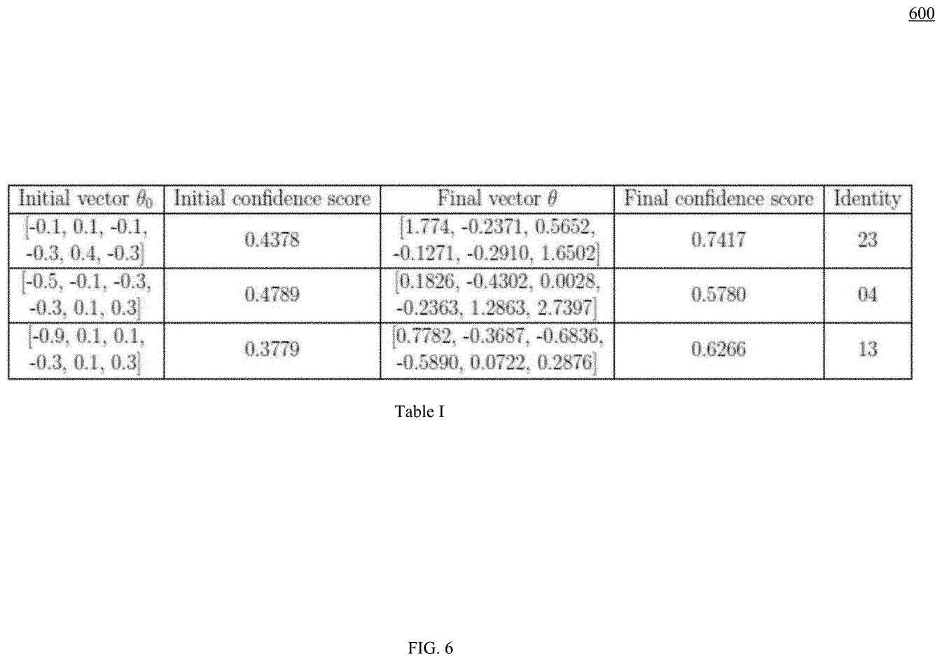

FIG. 6 is a diagram 600 of a table that illustrates a change in the parameter values on a confidence score, according to an embodiment. FIG. 6 illustrates Table 1 that illustrates initial parameter values (“Initial vector θ₀” column”), initial confidence score generated by FRS 110 for synthesized image 206 (“Initial confidence score” column), final parameter values (“Final vector θ” column), final confidence score generated by FRS 110 for synthesized image 206 (“Final confidence score” column), and identity or ID 218 for image 204R that FRS 110 matched against synthesized image 206 (“Identity” column). In the first row of Table 1, Table 1 illustrates the initial vector θ₀ column includes initial parameters θ^{T}=[−0.1, 0.1, −0.1, −0.3, 0.4, −0.3]. When synthesized image 206 is initialized with initial parameters θ^{T}=[−0.1, 0.1, −0.1, −0.3, 0.4, −0.3], FRS 110 may generate a confidence score of 0.4378 (“Initial confidence score” column) when FRS 110 matches synthesized image 206 against image 204R associated with ID=23 (“Identity” column). However, after one or more iterations shown in FIG. 2, the parameters of synthesized image 206 may have changed to parameter θ^{T}=[1.774, −0.2371, 0.5652, −0.1271, −0.2910, 1] as shown in the “Final vector θ” column in Table 1. When parameter θ^{T}=[1.774, −0.2371, 0.5652, −0.1271, −0.2910, 1], FRS 110 may match synthesized image 206 with image 204R associated with ID=23 and generate a confidence score of 0.7417, as shown in the “Final confidence score” and “Identity” columns in Table 1. Notably, by setting different values in parameter θ^{T}, the confidence score for synthesized image 206 improved from 0.4378 to 0.7417 when FRS 110 matched synthesized image 206 against the same image 204R that is associated with ID=23.

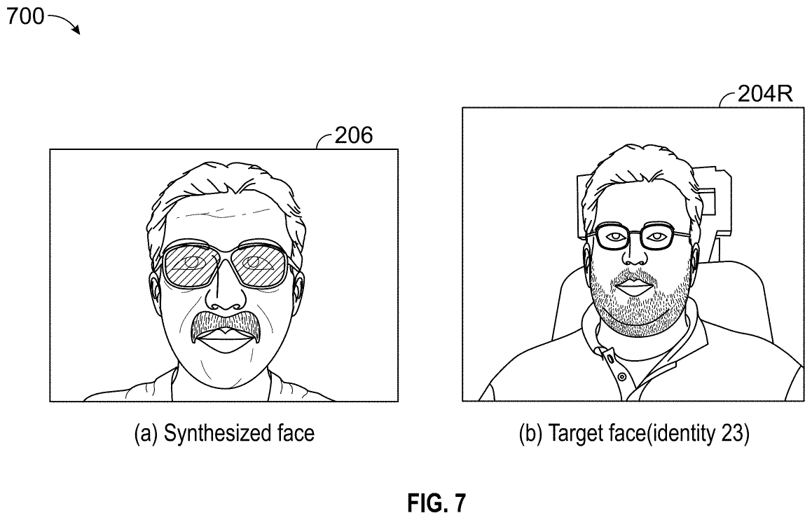

FIG. 7 is a diagram 700 of a successful simulated attack on an FRS, according to an embodiment. For example, FRS 110 matched synthesized image 206 with image 204R that is associated with ID=23. The parameters for synthesized image 206 may be parameters θ^{T}=[1.774, −0.2371, 0.5652, −0.1271, −0.2910, 1] discussed with reference to FIG. 6 above. In some embodiments, the system in FIG. 2 may have synthesized image 206 in FIG. 7 after multiple iterations and without constraining the parameters in vector θ.

With further reference to FIG. 2, as discussed above, synthesizer 108 may bind or constrain some or all parameters in vector θ. The constraints for each parameter may be determined by trial and error and as FRS 110 generates confidence scores for synthesized images 206. In some embodiments, synthesizer 108 may constrain the parameters so that synthesizer 108 may generate realistic synthesized images 206 (such as image 206A in FIG. 5) and not distorted images (such as image 206B in FIG. 5). In some embodiments, the bounds for parameters m, c, and e may be set as:

b=[(−0.5,0.5),(−0.5,0.5),(−1,0.5),(−1,0.5),(−0.5,0.5),(−0.5,0.5)]

where θ^{T}ϵb means:
−0.5≤m₁≤0.5
−0.5≤m₂≤0.5
−1≤c₁≤0.5
−1≤c₂≤0.5
−0.5≤e₁≤0.5
−0.5≤e₂≤0.5

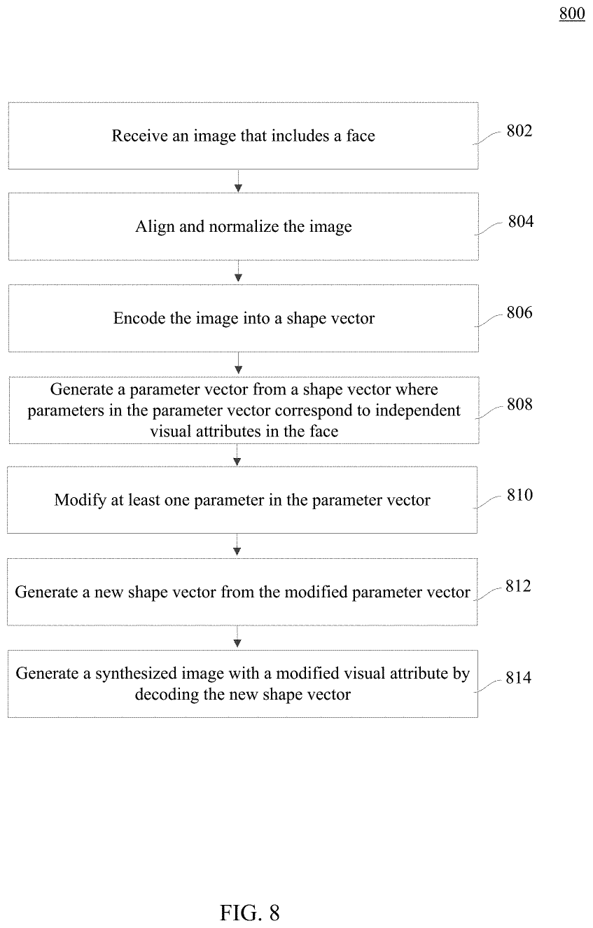

FIG. 8 is a flowchart of a method 800 for generating a synthesized image, according to an embodiment. Method 800 may be performed using hardware and/or software components described in FIGS. 1-7. Note that one or more of the operations, which are described in more detail above, may be deleted, combined, or performed in a different order as appropriate.

At operation 802, an image is received. For example, synthesizer 108 may receive adversarial image 204 or previously synthesized image 206.

At operation 804, the image is aligned and normalized. For example, synthesizer 108 may align adversarial image 204 or previously synthesized image 206 with registered images 204R. Synthesizer 108 may also apply one or more masks that remove visual attributes in adversarial image 204 or previously synthesized image 206, such as hair from a face or background.

At operation 806, the image is encoded. For example, synthesizer 108 may use a neural network to encode a face in adversarial image 204 or previously synthesized image 206 into encodings that correspond to appearance and shape of the face. The encodings may be included in a shape vector 302.

At operation 808, a parameter vector is generated. For example, the encodings generated in operation 806 may be used to generate a parameter vector 306 with parameters that correspond to different types of non-overlapping, orthogonal modes. As discussed above, the mode may correspond to visual attributes in the image or a face in the image and can be makeup, glasses, lipstick, etc. In some embodiments, encodings in shape vector 302 may be decomposed into parameter vector 306 using a MMDA decomposition, GAN decomposition, or another decomposition. In some embodiments, a configurable number of parameters in the parameter vector 306 may correspond to a single orthogonal mode.

At operation 810, parameters are modified. For example, synthesizer 108 may modify parameters in the parameter vector 306. As discussed above, the one or more parameters may be modified with or without preset constraints. Parameter vector 306 with the modified parameters is parameter vector 306N. Further, as discussed above, the one or more parameters may be modified within one or more parameter constraints that are associated with the one or more parameters. When parameters are constrained, synthesizer 108 may generate a more realistic synthesized image 206.

At operation 812, a new shape vector is generated. For example, shape vector 304N may be generated from parameter vector 306N in the process that is a reverse of operation 808. However, because the parameters in parameter vector 306N have been modified in operation 810, the shape vector 302N is different from shape vector 302 in operation 808.

At operation 814, synthesized image is synthesized. For example, synthesizer 108 may use a decoder to decode shape vector 304N into synthesized image 206.

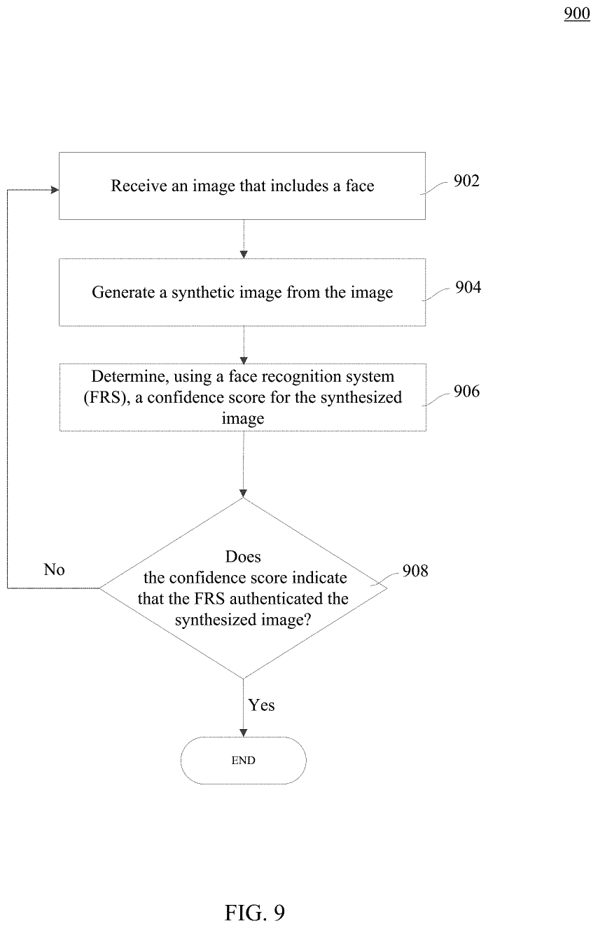

FIG. 9 is a flowchart of a method 900 for identifying vulnerabilities in a face recognition system, according to an embodiment. Method 900 may be performed using hardware and/or software components described in FIGS. 1-7.

At operation 902, an image is received. For example, synthesizer 108 may receive an image, which is an adversarial image 204 or a previously synthesized image. If image is adversarial image 204, synthesizer 108 may initialize parameters associated with attributes to initial parameter values 208.

At operation 904, a synthesized image is generated. For example, synthesizer 108 may generate synthesized image 206 from image received in operation 902 or from a previously synthesized image. Synthesized image 206 is generated as discussed in FIG. 8.

At operation 906, a confidence score is determined. For example, FRS 110 may receive synthesized image 206 and generate confidence score 212. Confidence score 212 indicates the likelihood that synthesized image 206 matches one of images 204R registered with FRS 110.

At operation 908, a confidence score is validated. For example, validation module 112 determines whether confidence score 212 indicates whether FRS 110 authenticated or did not authenticate synthesized image 206. If FRS 110 authenticated synthesized image 206, method 900 ends. Otherwise, method 900 proceeds to operation 902 where synthesizer 108 receives synthesized image 260 and regenerates synthesized image 206 at operation 904.

Referring now to FIG. 10 an embodiment of a computer system 1000 suitable for implementing, the systems and methods described in FIGS. 1-9 is illustrated.

In accordance with various embodiments of the disclosure, computer system 1000, such as a computer and/or a server, includes a bus 1002 or other communication mechanism for communicating information, which interconnects subsystems and components, such as a processing component 1004 (e.g., processor, micro-controller, digital signal processor (DSP), graphics processing unit (GPU), etc.), a system memory component 1006 (e.g., RAM), a static storage component 1008 (e.g., ROM), a disk drive component 1010 (e.g., magnetic or optical), a network interface component 1012 (e.g., modem or Ethernet card), a display component 1014 (e.g., CRT or LCD), an input component 1018 (e.g., keyboard, keypad, or virtual keyboard), a cursor control component 1020 (e.g., mouse, pointer, or trackball), a location determination component 1022 (e.g., a Global Positioning System (GPS) device as illustrated, a cell tower triangulation device, and/or a variety of other location determination devices known in the art), and/or a camera component 1023. In one implementation, the disk drive component 1010 may comprise a database having one or more disk drive components.

In accordance with embodiments of the disclosure, the computer system 1000 performs specific operations by the processor 1004 executing one or more sequences of instructions contained in the memory component 1006, such as described herein with respect to the mobile communications devices, mobile devices, and/or servers. Such instructions may be read into the system memory component 1006 from another computer readable medium, such as the static storage component 1008 or the disk drive component 1010. In other embodiments, hard-wired circuitry may be used in place of or in combination with software instructions to implement the disclosure.

Logic may be encoded in a computer readable medium, which may refer to any medium that participates in providing instructions to the processor 1004 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1010, volatile media includes dynamic memory, such as the system memory component 1006, and transmission media includes coaxial cables, copper wire, and fiber optics, including wires that comprise the bus 1002. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 1000. In various other embodiments of the disclosure, a plurality of the computer systems 1000 coupled by a communication link 1024 to the network 1402 (e.g., such as a LAN, WLAN, PTSN, and/or various other wired or wireless networks, including telecommunications, mobile, and cellular phone networks) may perform instruction sequences to practice the disclosure in coordination with one another.

The computer system 1000 may transmit and receive messages, data, information and instructions, including one or more programs (i.e., application code) through the communication link 1024 and the network interface component 1012. The network interface component 1012 may include an antenna, either separate or integrated, to enable transmission and reception via the communication link 1024. Received program code may be executed by processor 1004 as received and/or stored in disk drive component 1010 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A method comprising:
receiving an image that includes a face at an image synthesizer;
synthesizing, using the image synthesizer, the image into a synthesized image, wherein the synthesized image includes a change to at least one visual attribute of the face;
generating, using a face recognition system (FRS), a confidence score for the synthesized image; and
determining, using a distance function and the confidence score, whether the FRS authenticated the synthesized image.

2. The method of claim 1, further comprising:
synthesizing, using the image synthesizer, a second synthesized image from the synthesized image, wherein the second synthesized image includes a change to at least two visual attributes of the face;
generating, using the FRS, a second confidence score for the second synthesized image; and
determining, using the distance function and the second confidence score, that the FRS has authenticated the second synthesized image.

3. The method of claim 1, wherein the synthesizing the image further comprises masking at least one visual attribute of the image that is not the face in the image.

4. The method of claim 1, wherein the synthesizing further comprising:
isolating, using an encoder of a neural network, at least one parameter that corresponds to a visual attribute in the at least one visual attribute;
modifying the at least one parameter into a at least one modified parameter; and
synthesizing, using a decoder, the synthesized image using the at least one modified parameter.

5. The method of claim 4, wherein the at least one visual attribute of the face is associated with a configurable number of parameters.

6. The method of claim 4, further comprising:
iteratively resynthesizing the synthesized image by modifying the at least one parameter associated with the at least one visual attribute and regenerating the confidence score using the FRS until a distance function and the confidence score indicate that the FRS authenticated the synthesized image.

7. The method of claim 4, wherein the modifying comprises:
modifying a value of the at least one parameter between a first parameter constraint and a second parameter constraint.

8. The method of claim 4, wherein the modifying comprises:
modifying a value of the at least one parameter without a constraint.

9. A system comprising:
a non-transitory memory storing instructions; and
one or more hardware processors coupled to the non-transitory memory and configured to read the instructions from the non-transitory memory to cause the system to perform operations comprising:
receive an adversarial image that includes a face, wherein the adversarial image includes the face that is not registered with a face recognition system (FRS); and
iteratively synthesizing, using an image synthesizer, the adversarial image into a synthesized image until the FRS identifies the synthesized image as a genuine image associated with the FRS as determined by a distance function, wherein the synthesizing modifies at least one visual attribute of the face in the adversarial image or a previously synthesized image.

10. The system of claim 9, wherein at each iteration the image synthesizer includes instructions that further cause the system to perform operations comprising:
masking a visual attribute in the at least one visual attribute in the adversarial image, wherein the visual attribute is not included in the face in the adversarial image;
isolating a parameter in the plurality of parameters that corresponds to the visual attribute;
modifying a value of the parameter; and
generating the synthesized image using the plurality of parameters including the modified parameter.

11. The system of claim 10, wherein the parameter in the plurality of parameters includes at least one of a make-up parameter associated with a make-up visual attribute, a spectacle parameter associated with a spectacle visual attribute, or an expression parameter associated with an expression visual attribute.

12. The system of claim 10, wherein the parameter and a second parameter correspond to visual attribute in the face.

13. The system of claim 10, wherein the image synthesizer includes instructions that further cause the system to perform operations comprising:
constraining the value of the parameter between a first constraint and a second constraint.

14. The system of claim 10, wherein the image synthesizer includes instructions that further cause the system to perform operations comprising:
modifying the value of the parameter without constraining the value.

15. The system of claim 9, wherein the modified at least one visual attribute includes a first visual attribute and a second visual attribute that is independent from the first visual attribute, wherein the first visual attribute is independent from the second visual attribute when a first parameter and a second parameter modify the first visual attribute and a third parameter and a fourth parameter modify the second visual attribute.

16. A non-transitory machine-readable medium having stored thereon machine-readable instructions executable to cause a machine to perform operations for determining an attack on a neural network, the operations comprising:
receiving an image at an image synthesizer;
synthesizing, using the image synthesizer, the image into a synthesized image, wherein the synthesized image includes changes to at least one visual attribute of a face in the adversarial image;
generating, using a face recognition system (FRS), a confidence score for the synthesized image, wherein the FRS is coupled to a memory that stores a plurality of images registered with the FRS;
based on the confidence score and a distance function, determining that the synthesized image is the adversarial image;
re-synthesizing, using the image synthesizer, the synthesized image into a second synthesized image, wherein the second synthesized image includes a change to a second visual attribute of the face in the synthesized image;
generating, using the FRS, a second confidence score for the second synthesized image; and
based on the second confidence score the distance function, authenticating the second synthesized image.

17. The non-transitory machine-readable medium of claim 16, wherein the operations further comprise:
identifying a face portion of the adversarial image;
identifying a plurality of parameters that correspond to the face portion;
isolating a parameter that corresponds to a visual attribute in the at least one visual attribute from a plurality of parameters;
modifying a value of the parameter; and
synthesizing the synthesized image using the modified parameter and the plurality of parameters.

18. The non-transitory machine-readable medium of claim 17, wherein the at least one visual attribute is associated with at least two parameters in the plurality of parameters.

19. The non-transitory machine-readable medium of claim 17, wherein the operations further comprise:
masking at least one non-face portion of the adversarial image prior to identifying the plurality of parameters.

20. The non-transitory machine-readable medium of claim 17, wherein a change to a first visual attribute in the plurality of visual attributes is independent of the change in the second visual attribute in the plurality of visual attributes.
